(19) United States
(12) Patent Application Publication
(10) Pub. No.: US 2009/0218929 A1
(43) Pub. Date: Sep. 3, 2009

(54) COLD CATHODE FLUORESCENT LAMP

(75) Inventors: Kyung Ran KIM, Siheung (KR); Young Pyo MOON, Wonju (KR)

Correspondence Address: Workman Nydegger;1000 Eagle Gate Tower, 60 East South Temple, Salt Lake City, UT, 84111, US

(73) Assignee: WOOREE ETI CO., LTD., Ansan-si (KR)

(21) Appl. No.: 12/108,461

(22) Filed: Apr. 23, 2008

(30) Foreign Application Priority Data
Feb. 28, 2008 (KR) 10-2008-0018393

(51) Int. Cl. H01J 1/62

(52) U.S. Cl. 313/491

(57) ABSTRACT

A cold cathode fluorescent lamp is disclosed. The cold cathode fluorescent lamp includes a sealed glass tube provided with a fluorescent layer on an inner surface thereof, inner electrodes provided in opposite ends of the glass tube, and outer electrodes to apply an electric field to the inner electrodes. Each of the inner electrodes includes a first electrode formed in a cup shape and a second electrode provided inside the first electrode and formed in a coil shape.

This application claims the benefit of Korean Patent Application No. 10-2008-0018393, filed on Feb. 28, 2008, which is hereby incorporated by reference as if fully set forth herein.

### BACKGROUND OF THE INVENTION

1. Field of the Invention

The present invention relates to a cold cathode fluorescent lamp, and more particularly, to a cold cathode fluorescent lamp capable of extending its life.

2. Discussion of the Related Art

With the progress of information-dependent society, the demand for various display devices has increased. To meet such a demand, efforts have recently been made to develop flat panel display devices.

Flat panel display devices are classified into liquid crystal display (LCD) devices, field emission display (FED) devices, plasma display panels (PDPs) electroluminescent display (ELD) devices, and the like.

In particular, LCDs are being practically applied to various appliances for display purposes because LCDs have advantages of low weight, thinness, low power consumption, etc. Thus, LCDs are currently widely used. Various applications of LCDs are being developed in association with portable computers such as laptop computers, office automated machines, audio/video equipments, indoor/outdoor advertising devices, and so on. Recently, LCDs with a large scale and a high resolution are being rapidly developed, and are mass-produced.

An LCD device displays a desired image on a screen by controlling light transmittance e incident upon a display panel according to an image signal applied to a plurality of switches for control, which are arranged in a matrix shape.

A general LCD device includes a liquid crystal display module and a driving circuit part to drive the liquid crystal display module.

The liquid crystal display module includes a liquid crystal display panel in which liquid crystal cells are arranged in a matrix shape between two glass substrates, and a backlight unit to emit light to the liquid crystal display panel.

Meanwhile, most LCD devices must use a separate light source, namely, a backlight unit, to illuminate an LCD panel because such an LCD is a light reception type display device which uses light externally received and adjusted in amount to display an image. Generally, such a backlight unit is classified into an edge type and a direct type in accordance with a mounting position of a lamp unit.

Most LCD devices use a cold cathode fluorescent lamp (CCFL) as a light source. A cold cathode fluorescent lamp emits white light with low heat generation, and has advantages of low power consumption and long life, when compared to other types of light sources.

A conventional cold cathode fluorescent lamp will now be explained with reference to the annexed drawings.

FIG. 1 is a perspective view illustrating a conventional cold cathode fluorescent lamp, and FIG. 2 is a sectional view taken along line I-I′ in FIG. 1.

Referring to FIGS. 1 and 2, a conventional cold cathode fluorescent lamp 20 includes a transparent glass tube 14 formed with a discharge space, inner electrodes 18 having cathode and anode provided in the opposite ends of the glass tube 14, and outer electrodes to apply an electric field to the inner electrodes 18. Each of the outer electrodes includes an inner lead wire 10 connected to an end of each of the inner electrodes 18, and an outer lead wire 8 connected to the inner lead wire 10.

A discharge gas for light emission from the cold cathode fluorescent lamp 20 is filled in the glass tube 14. An inert gas, such as hydrargyrum (Hg), neon (Ne), krypton (Kr), argon (Ar), xenon (Xe) or the like, is used as the discharge gas.

On an inner wall of the glass tube 14 are formed a protective layer (not shown) to protect the glass tube 14 and a fluorescent layer 16 to generate visible light by a stimulus from ultraviolet light formed by electric discharge.

A light emitting principle of such a conventional cold cathode fluorescent lamp 20 is as follows. If an electric field is applied to the inner electrodes 18 provided in both the ends of the glass tube 14 from the outer electrodes, an electric field difference is generated between the two inner electrodes 18. If an electric field is formed at the inner electrodes 18, an electric discharge occurs in the glass tube 14, and electrons generated by the electric discharge move across the glass tube 14, from one inner electrode 18 to the other inner electrode 18.

The electrons moving thus collide with the discharge gas filled in the glass tube 14, and the collision dissociates the discharge gas into ions, electrons and neutrons.

A conductive plasma environment is made in the glass tube 14, and ultraviolet light generated at this time stimulates fluorescent substances of the fluorescent layer 16, thereby visible light being generated. By such a principle, the cold cathode fluorescent lamp 20 emits light.

With a recent trend of commercialization of an LCD using a cold cathode fluorescent lamp and production of a large-scaled screen, the cold cathode fluorescent lamp 20 should have a longer length, and higher voltage should be applied to the cold cathode fluorescent lamp 20. Accordingly, hydrargyrum injected in the cold cathode fluorescent lamp 20 is consumed due to lighting for a long time, thus luminance is deteriorated, and life of the lamp is shortened.

Life of the lamp may be extended by increasing a surface area of the electrodes. However, there is a limitation in increasing a surface area of the electrodes. In other words, if a length of the electrodes is increased, a surface area of the electrodes is expanded, and life of the lamp can be extended. But, because the electrodes are a non-light emitting part, the increase in a length of the electrodes causes decrease in an effective light emitting length of the lamp, and accordingly luminance uniformity on a display screen is deteriorated.

### SUMMARY OF THE INVENTION

Accordingly, the present invention is directed to a cold cathode fluorescent lamp that substantially obviates one or more problems due to limitations and disadvantages of the related art.

An object of the present invention is to provide a cold cathode fluorescent lamp capable of extending its life.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a cold cathode fluorescent lamp comprises: a sealed glass tube provided with a fluorescent layer on an inner surface thereof; inner electrodes provided in opposite ends of the glass tube, each of the inner electrodes including a first electrode formed in a cup shape and a second electrode provided inside the first electrode and formed in a coil shape; and outer electrodes to apply an electric field to the inner electrodes.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a conventional cold cathode fluorescent lamp;

FIG. 2 is a sectional view taken along line I-I′ in FIG. 1;

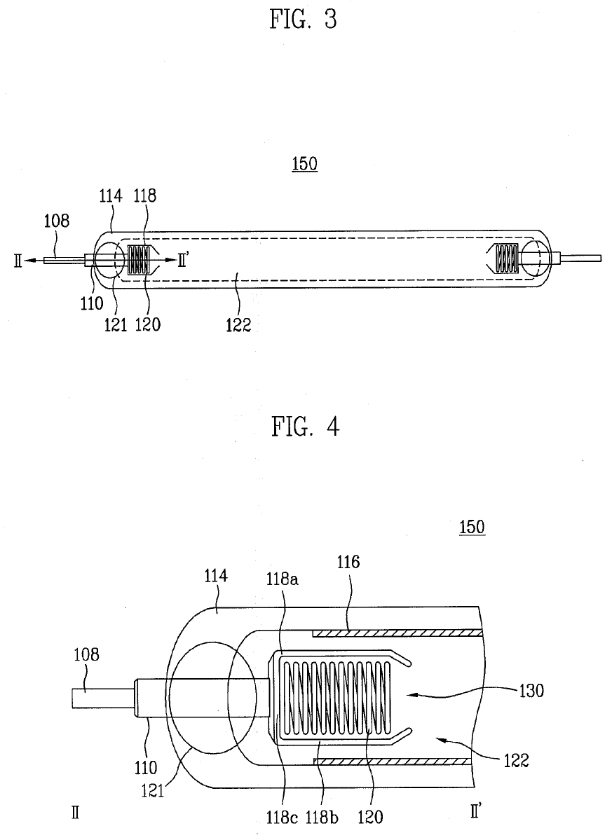

FIG. 3 is a perspective view illustrating a cold cathode fluorescent lamp in accordance with the present invention;

FIG. 4 is a sectional view taken along line II-II′ in FIG. 3;

FIG. 5 is a graph showing relation of a length and a surface area of an electrode between the conventional cold cathode fluorescent lamp and the inventive cold cathode fluorescent lamp;

FIG. 6 is a graph showing relation of a lamp temperature and a material of an electrode between the conventional cold cathode fluorescent lamp and the inventive cold cathode fluorescent lamp;

FIG. 7 is a graph showing relation of a maintenance ratio of a sputter yield and life between the conventional cold cathode fluorescent lamp and the inventive cold cathode fluorescent lamp; and

FIGS. 8 to 10 are sectional views illustrating modified examples of an inner electrode of the cold cathode fluorescent lamp in accordance with the present invention.

### DETAILED DESCRIPTION OF THE INVENTION

Reference will now be made in detail to the preferred embodiments of the present invention associated with a cold cathode fluorescent lamp, examples of which are illustrated in the accompanying drawings. Wherever possible, the same reference numbers will be used throughout the drawings to refer to the same or like parts.

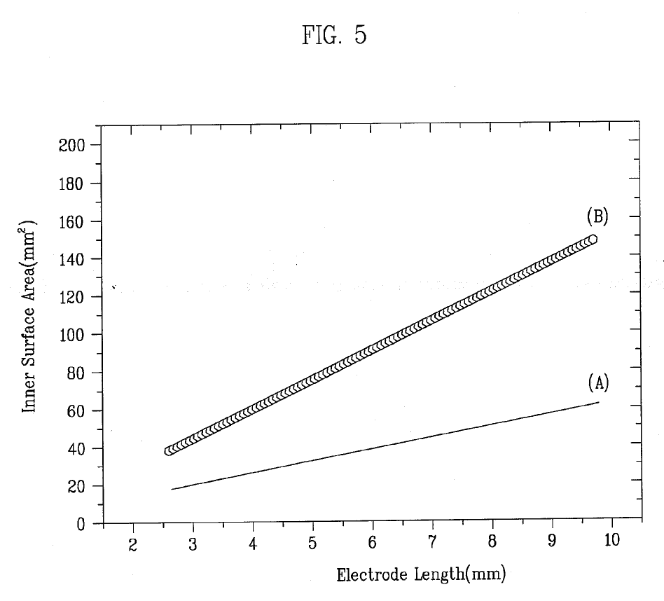

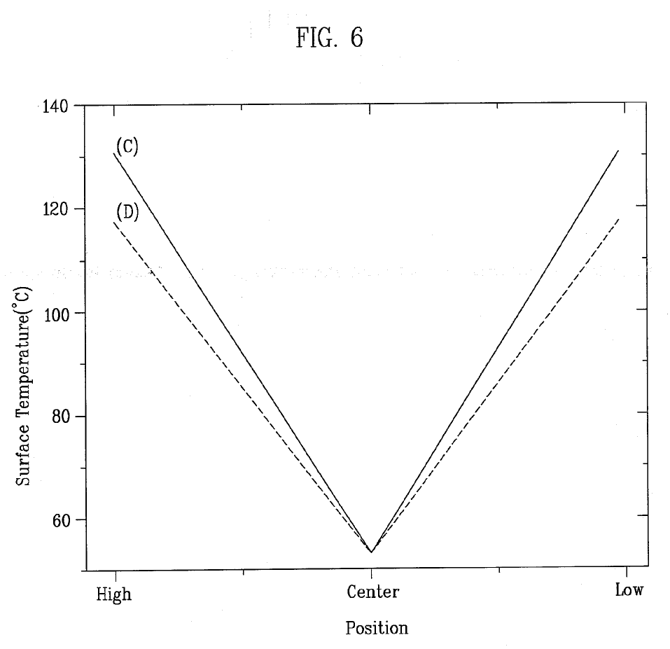

FIG. 3 is a perspective view illustrating a cold cathode fluorescent lamp in accordance with the present invention, and FIG. 4 is a sectional view taken along line II-II′ in FIG. 3.

Referring to FIGS. 3 and 4, a cold cathode fluorescent lamp 150 according to the present invention includes a glass tube 114 formed with a discharge space 122, inner cathode and inner anode electrodes provided in the opposite ends of the glass tube 114, and outer electrodes to apply an electric field to the inner electrodes.

Each of the outer electrodes includes an inner lead wire 110 connected to an end of each of the inner electrodes, and an outer lead wire 108 connected to the inner lead wire 110. The inner lead wire 110 is fused to the glass tube 114 to be connected to the inner electrode positioned inside the glass tube 114, and is protected by a bead glass 121.

The inner lead wire 110 includes a surface made of nickel (Ni) having a good heat conductivity, tungsten (W) having a linear expansion coefficient similar to the bead glass 121, or molybdenum (Mo) capable of rapidly cooling the inner electrode. The outer lead wire 108 includes a surface made of dumet, which is an alloy of iron (Fe) and nickel (Ni) or nickel (Ni).

The glass tube 114 is made of a transparent material having a high light transmission, and is formed with a space 122 thereinside for electric discharge. A discharge gas for light emission is filled in the discharge space 122 of the glass tube 114. An inert gas, such as hydrargyrum (Hg), neon (Ne), krypton (Kr), argon (Ar), xenon (Xe) or the like, is used as the discharge gas filled in the glass tube 114.

On an inner wall of the glass tube 114 are formed a protective layer (not shown) to protect the glass tube 114 and a fluorescent layer 116 to generate visible light by a stimulus from ultraviolet light formed by electric discharge.

In such a cold cathode fluorescent lamp 150, if electric current is supplied to the inner electrodes through the outer lead wires 108 and the inner lead wires 110 from an external power source, electric discharge is generated in the glass tube 114. Ultraviolet light generated by the electric discharge excites the fluorescent layer 116, and visible light is emitted outside to be used as back light of an LCD device.

Each of the inner electrodes provided at the opposite ends of the cold cathode fluorescent lamp 150 includes a first electrode 118 formed in a cup shape, and a second electrode 120 formed in a coil shape, which is received in the cup-shaped first electrode 118.

The first electrode 118 includes an upper surface portion 118a, a lower surface portion 118b formed while opposing the upper surface portion 118a, and a side surface portion 118c connecting the upper surface portion 118a and the lower surface portion 118b. The upper surface portion 118a, the lower surface portion 118b and the side surface portion 118c define a receiving portion 130, in which the second electrode 120 is received. A distance between the upper surface portion 118a and the lower surface portion 118b is constant.

The first electrode 118 is made of nickel (Ni) or a nickel alloy. The second electrode 120 is made of a material selected from the group consisting of molybdenum (Mo), niobium (Nb), tungsten (W), tantalum (Ta) and an alloy thereof.

Nickel (Ni) or a nickel alloy, which is used to make the first electrode 118, has weak electrical properties, but has strong resistance to sputtering. The discharge gas filled in the glass tube 114 is activated by a driving voltage, and emits ions and electrons. At this time, the ions collide with the inner wall of the glass tube 114, which is a so-called sputtering phenomenon. By the sputtering phenomenon of that the ions collide with the inner wall of the glass tube 114, pinholes are generated. Such a problem can be prevented by making the first electrode 118 of nickel (Ni) or a nickel alloy which has strong resistance to sputtering.

Molybdenum (Mo), niobium (Nb), tungsten (W) or tantalum (Ta), which is used to make the second electrode 120, is a material having a low work function, a high melting point and weak resistance to sputtering, however has advantages of good temperature and electrical properties. Further, since the above material of the second electrode 120 can reduce consumption of hydrargyrum, it can reduce power consumption and extend life of the lamp.

Here, molybdenum (Mo) has a work function of 4.27 eV, niobium (Nb) has a work function of 4.3 eV, tungsten (W) has a work function of 4.5 eV, and tantalum (Ta) has a work function of 4.12 eV. As a work function of a metal is lower, electron emission at a low voltage is increased, thereby reducing power consumption of the cold cathode fluorescent lamp 150, increasing secondary electron emission, extending life and enhancing light emitting efficiency.

As a result, by providing the first electrode 118, which is made of nickel (Ni) or a nickel alloy having strong resistance to sputtering, and providing the second electrode 120, which is made of a material selected from the group consisting of molybdenum (Mo), niobium (Nb), tungsten (W), tantalum (Ta) and an alloy thereof having good temperature and electrical properties, inside the first electrode 118, the present invention has effects such that power consumption of the cold cathode fluorescent lamp 150 is reduced, secondary electron emission is increased, life is extended, light emitting efficiency is enhanced, and generation of pinholes caused by the sputtering phenomenon is minimized.

In some cases, the first electrode 118 may be made of the material used for the second electrode 120, and the second electrode 120 may be made of the material used for the first electrode 118.

Also, the formation of the coil-shaped second electrodes 120 inside the first electrodes 118 creates increase in a surface area of the electrodes and expansion of a discharge area. Accordingly, the number of electrons emitted from the electrodes is increased, and as a result life of the lamp can be extended. Also, by virtue of the increase in a surface area due to the second electrodes 120, a length of the inner electrodes can be reduced, and accordingly an effective light emitting length of the cold cathode fluorescent lamp 150 is increased, thereby enhancing luminance uniformity on a display screen.

The upper surface portion 118a and the lower surface portion 118b of the cup-shaped first electrode 118 are formed such that a front end portion of the upper surface portion 118a and a front end portion of the lower surface portion 118b are bent to be smaller than a maximum diameter of the receiving portion 130. Thus, the bent front end portions of the upper surface portion 118a and the lower surface portion 118b can fix the second electrode 120 to the first electrode 118, and can prevent separation of the second electrode 120 without welding the second electrode 120 to the first electrode 118.

A light emitting principle of the cold cathode fluorescent lamp 150 according to the present invention is as follows. If an electric field is applied to the inner electrodes provided in both the ends of the glass tube 114 through the outer lead wires 108 and the inner lead wires 110 from the external power source, an electric field difference is generated between the two inner electrodes.

If an electric field is formed at the inner electrodes, electric discharge occurs in the glass tube 114, and electrons generated by the electric discharge move across the glass tube 114, from one inner electrode to the other inner electrode. The electrons moving thus collide with the discharge gas filled in the glass tube 114, and the collision dissociates the discharge gas into ions, electrons and neutrons.

A conductive plasma environment is made in the glass tube 114, and ultraviolet light generated at this time stimulates fluorescent substances of the fluorescent layer, thereby visible light being generated. By such a principle, the cold cathode fluorescent lamp emits light.

The formation of the coil-shaped second electrodes 120 creates increase in a surface area of the electrodes and expansion of a discharge area. Accordingly, the number of electrons emitted from the electrodes is increased, a driving voltage of the lamp is decreased, life of the lamp is extended, and luminance of the lamp is enhanced. Also, the increase in the surface area of the inner electrodes creates increase in a heat emitting area and enhancement of heat emitting efficiency, thereby extending life of the lamp. For instance, the life of the cold cathode fluorescent lamp 150 according to the present invention can be extended to 40,000 hours or more.

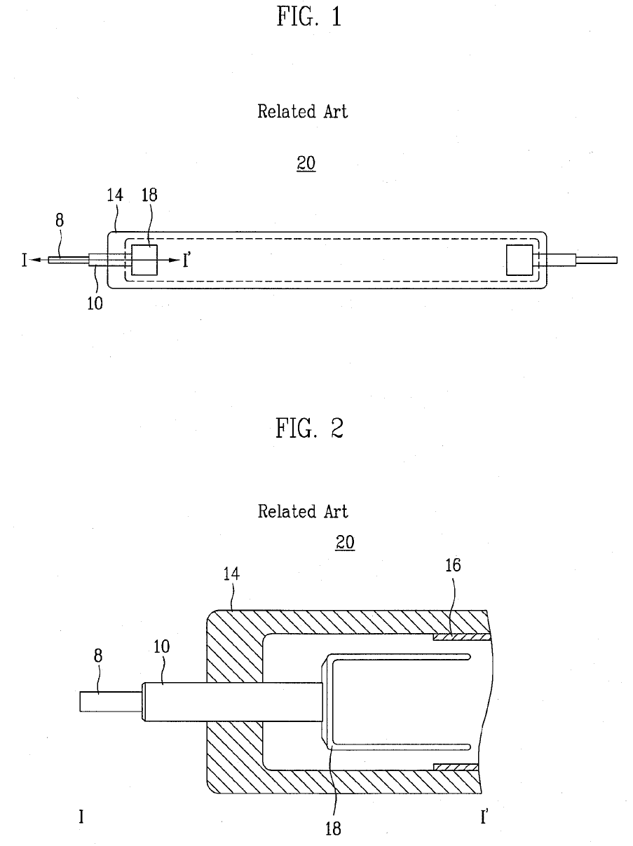

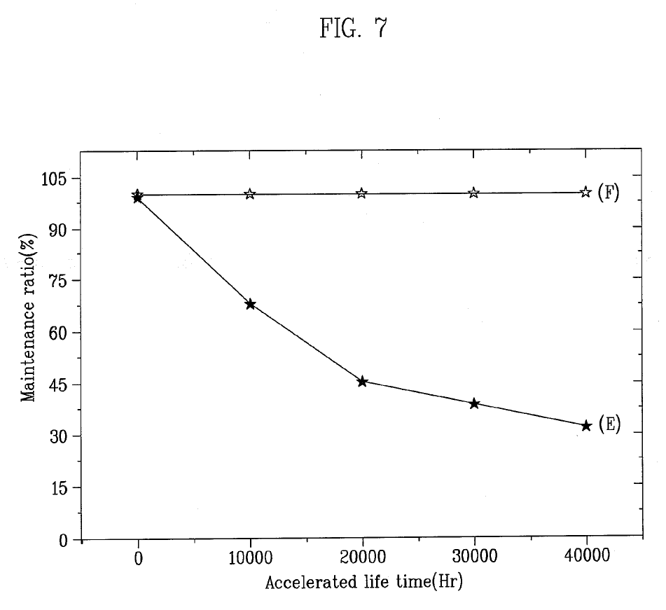

FIG. 5 is a graph showing relation of a length and a surface area of the electrode between the conventional cold cathode fluorescent lamp 20 (refer to FIG. 1) and the inventive cold cathode fluorescent lamp 150.

Referring to FIG. 5, a graph (A) shows a diameter and a surface area of the first electrode 18 (refer to FIG. 1) of the conventional cold cathode fluorescent lamp 20 (refer to FIG. 1). The conventional first electrode 18 (refer to FIG. 1) has a diameter of Φ1.7. A graph (B) shows a diameter and a surface area of the first electrode 118 added with the second electrode 120 according to the present invention.

At this time, the first electrode 118 has a diameter of Φ1.7, and the coil-shaped second electrode 120 has a wire diameter of Φ0.12. The second electrode 120 has a pitch which is ½ to 3/2 of the wire diameter, in order to minimize interference between electric charges. If the pitch is too small, energy is lost due to collision between the electric charges, and surface area effect is decreased. On the other hand, if the pitch is too large, increase in the surface area and durable effect of sputtering cannot be obtained as much as desired. In this regard, it is necessary to set the pitch to a proper value.

It can be known from the graph of FIG. 5 that the surface area effect at the length of 10 mm in the conventional lamp including only the first electrode 18 (refer to FIG. 1) is the same as the surface area effect at the length of 4 mm in the inventive lamp including the first electrode 118 added with the second electrode 120. Accordingly, the formation of the second electrodes 120 inside the first electrodes 118 creates increase in a surface area of the electrodes and expansion of a discharge area. Therefore, the number of electrons emitted from the electrodes is increased, a driving voltage of the lamp is decreased, life of the lamp is extended, and luminance of the lamp is enhanced.

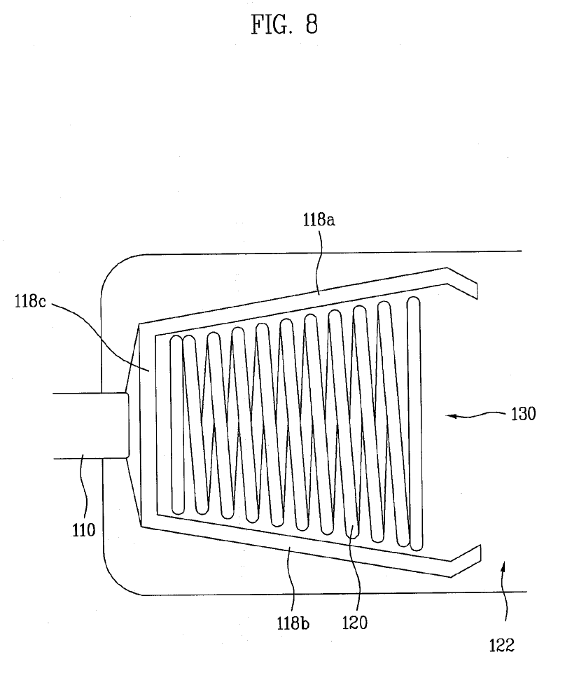

FIG. 6 is a graph showing relation of a lamp temperature and a material of the electrode between the conventional cold cathode fluorescent lamp 20 (refer to FIG. 1) and the inventive cold cathode fluorescent lamp 150.

Referring to FIG. 6, a graph (C) shows a surface temperature of the conventional cold cathode fluorescent lamp 20 (refer to FIG. 1) including the first electrode 18 (refer to FIG. 1) made of nickel (Ni). A graph (D) shows a surface temperature of the inventive cold cathode fluorescent lamp 150 including the first electrode 118 made of nickel (Ni) and the second electrode 120 made of tungsten (W). It can be known from the graph of FIG. 6 that the inventive cold cathode fluorescent lamp 150 including the first electrode 118 made of nickel (Ni) and the second electrode 120 made of tungsten (W) has a surface temperature lower than the conventional cold cathode fluorescent lamp 20 (refer to FIG. 1) including the first electrode 18 (refer to FIG. 1) made of nickel (Ni) has.

As such, by providing the second electrodes 120 made of tungsten (W) having good temperature properties and a high melting point, a surface temperature of the lamp can be decreased. Also, the formation of the second electrodes 120 increases a surface area of the inner electrodes and a heat emitting area, and enhances heat emitting efficiency, thereby extending life of the lamp.

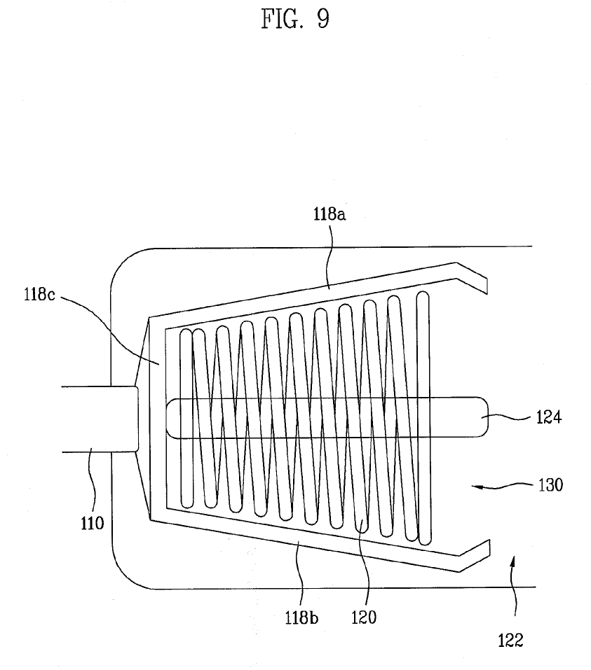

FIG. 7 is a graph showing relation of a maintenance ratio of a sputter yield and life between the conventional cold cathode fluorescent lamp 20 (refer to FIG. 1) and the inventive cold cathode fluorescent lamp 150.

Referring to FIG. 7, a graph (E) shows a sputter yield of the conventional cold cathode fluorescent lamp 20 (refer to FIG. 1) including the first electrode 18 (refer to FIG. 1) made of nickel (Ni) as time passes by. It can be known from the graph (E) that the sputter yield is decreased as time passes by. A graph (F) shows a sputter yield of the inventive cold cathode fluorescent lamp 150 including the first electrode 118 made of nickel (Ni) and the second electrode 120 made of tungsten (W) as time passes by. It can be known from the graph (F) that the sputter yield can be maintained constant as time passes by.

As such, by providing the second electrode 120 made of tungsten (W) having strong electrical properties, and providing the first electrode 118, which is made of nickel (Ni) having strong resistance to sputtering, outside the second electrode 120, the present invention has effects such that a sputter yield is maintained constant as time passes by, and accordingly light emitting efficiency can be enhanced, and life of the lamp can be extended.

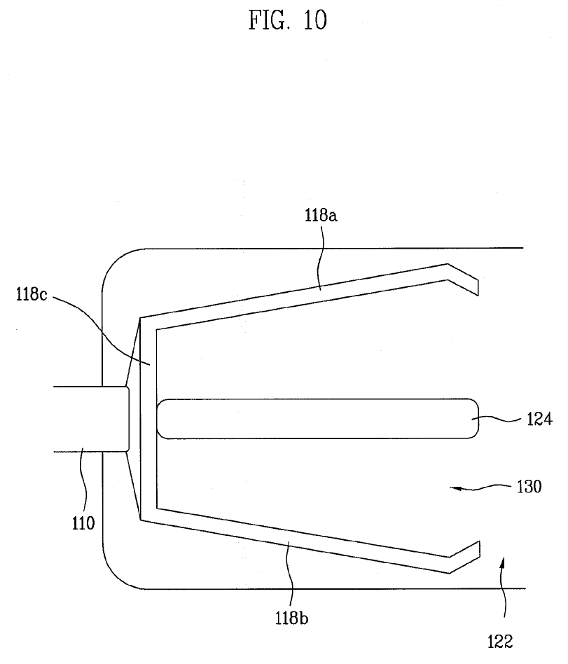

The inner electrodes may be formed in other shapes as illustrated in FIGS. 8 to 10.

Since cold cathode fluorescent lamps including the modified examples of the inner electrodes illustrated in FIGS. 8 to 10 have substantially the same constitution as the cold cathode fluorescent lamp 150 illustrated in FIGS. 3 and 4, only the modified examples of the inner electrodes will be explained hereinafter.

Referring to FIG. 8, the first electrode 118 of each of the inner electrodes is formed in a cup shape. The upper surface portion 118a and the lower surface portion 118b of the first electrode 118 are formed such that a distance between the upper surface portion 118a and the lower surface portion 118b is gradually increased as it goes toward a center portion of the discharge space 122.

The second electrode 120 is formed in a coil shape, and is provided inside the first electrode 118. Further, the second electrode 120 is formed such that a winding length of the second electrode 120 between the upper surface portion 118a and the lower surface portion 118b of the first electrode 118 is gradually increased as it goes toward a center portion of the discharge space 122.

In other words, as it goes toward a center portion of the discharge space 122 of the glass tube 114 from the outer electrodes, a surface area of the inner electrodes is increased, and a discharge area is expanded. Accordingly, the number of electrons emitted from the electrodes is increased, and as a result life of the lamp can be extended.

Referring to FIG. 9, a third electrode 124, which is formed in a bar shape, may be further provided in the receiving portion 130 of the first electrode 118. The cup-shaped first electrode 118 may be formed similar to FIG. 8, such that a distance between the upper surface portion 118a and the lower surface portion 118b is gradually increased as it goes toward a center portion of the discharge space 122. Alternatively, the cup-shaped first electrode 118 may be formed similar to FIG. 4, such that a distance between the upper surface portion 118a and the lower surface portion 118b is constant.

Referring to FIG. 10, the inner electrode may include the cup-shaped first electrode 118 and the bar-shaped third electrode 124 provided inside the first electrode 118 (the second electrode is eliminated from the inner electrode). The third electrode 124 may be made of the same material as the first electrode 118, or may be made of the same material as the second electrode 120 (refer to FIGS. 4, 8 and 9).

The cold cathode fluorescent lamp in accordance with the present invention may have the following advantageous effects.

First, by providing the coil-shaped second electrode inside the first electrode of each of the inner electrodes, a surface area of the inner electrodes is increased, and accordingly a discharge area is expanded, and the number of electrons emitted from the electrodes is increased. As a result, life of the lamp can be extended. Further, the increase in a surface area by the second electrode creates decrease in a length of the inner electrodes. Accordingly, an effective light emitting length of the cold cathode fluorescent lamp is increased, and luminance uniformity on a display screen is enhanced.

Second, by providing the first electrode made of a material having strong resistance to sputtering, and providing the second electrode, which is made of a material having good temperature and electrical properties, inside the first electrode, power consumption of the cold cathode fluorescent lamp can be reduced, secondary electron emission can be increased, life of the lamp can be extended, light emitting efficiency of the lamp can be enhanced, and generation of pinholes caused by the sputtering phenomenon can be minimized.

Third, by making the second electrode of a material having good temperature properties and a high melting point, a surface temperature of the lamp can be lowered. Further, the formation of the second electrode increases a surface area of the inner electrodes and a heat emitting area. Accordingly, heat emitting efficiency is enhanced, and as a result life of the lamp can be extended.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A cold cathode fluorescent lamp comprising:
a sealed glass tube provided with a fluorescent layer on an inner surface thereof;
inner electrodes provided in opposite ends of the glass tube, each of the inner electrodes including a first electrode formed in a cup shape and a second electrode provided inside the first electrode and formed in a coil shape; and
outer electrodes to apply an electric field to the inner electrodes.

2. The cold cathode fluorescent lamp according to claim 1, wherein one of the first electrode and the second electrode is made of nickel (Ni) or a nickel alloy, and
the other one of the first electrode and the second electrode is made of a material selected from the group consisting of molybdenum (Mo), niobium (Nb), tungsten (W), tantalum (Ta) and an alloy thereof.

3. The cold cathode fluorescent lamp according to claim 1, wherein the first electrode includes an upper surface portion, a lower surface portion formed while opposing the upper surface portion, and a side surface portion connecting the upper surface portion and the lower surface portion,
and wherein the upper surface portion, the lower surface portion and the side surface portion define a receiving portion.

4. The cold cathode fluorescent lamp according to claim 3, wherein the upper surface portion and the lower surface portion are arranged at a distance from each other,
and wherein the distance is set to be constant.

5. The cold cathode fluorescent lamp according to claim 3, wherein the upper surface portion and the lower surface portion are arranged at a distance from each other,
and wherein the distance is set to be increased in one direction.

6. The cold cathode fluorescent lamp according to claim 3, wherein the upper surface portion and the lower surface portion have front end portions which are bent to be smaller than a maximum diameter of the receiving portion.

7. The cold cathode fluorescent lamp according to claim 3, wherein each of the inner electrodes further includes a third electrode which is provided in the receiving portion and formed in a bar shape.

8. The cold cathode fluorescent lamp according to claim 7, wherein the first electrode and the third electrode are made of the same material.

9. The cold cathode fluorescent lamp according to claim 7, wherein the second electrode and the third electrode are made of the same material.

10. The cold cathode fluorescent lamp according to claim 1, wherein the second electrode has a pitch which is ½ to 3/2 of a wire diameter.
